(19) United States
(12) Patent Application Publication
(10) Pub. No.: US 2012/0001003 A1
(43) Pub. Date: Jan. 5, 2012

(54) DEVICE AND METHOD FOR PROCESSING WASTE MATERIALS

(76) Inventor: Mark DAVIS, Mansfield, OH (US)

(21) Appl. No.: 13/046,336

(22) Filed: Mar. 11, 2011

Related U.S. Application Data
(60) Provisional application No. 61/313,011, filed on Mar. 11, 2010.

(51) Int. Cl. B02C 23/04; B02C 23/08

(52) U.S. Cl. 241/37.5; 241/68; 241/101.1

(57) ABSTRACT

A medical waste processing device includes an outer housing, chamber having a passageway through which material passes, and cutting member contained within the chamber that cuts and shreds the waste material before entering a waste receptacle. A plunger is also provided that may be inserted into the chamber to facilitate passage of the waste material through the device. A vacuum and filter system is further provided to capture and filter potentially harmful aerosols that may be emitted during operation of the device. A method is also provided for reducing the volume of waste material through operation of the electrical shredding device.

### CROSS REFERENCE TO RELATED APPLICATIONS

The present application claims the benefit of the filing date under 35 U.S.C. §119(e) of U.S. Provisional Application Ser. No. 61/313,011 filed on Mar. 11, 2010, which is incorporated herein by reference in its entirety.

### TECHNICAL FIELD

The disclosure relates to a device and method for processing medical waste.

### BACKGROUND

The problems associated with the destruction and decontamination of medical waste are well-known. Syringes, plastic blood bags, metal clips, hoses, etc. present formidable problems for disposal. Not only are they difficult to deal with due to safety risks to handlers and health compliance regulations, but also they are contaminated with viral and bacterial pathogens which make their handling hazardous. These items must be decontaminated, rendered harmless and disposed of to prevent the transmission of disease, and to avoid accessibility of used needles and syringes and for purposes of general sanitation.

Devices adapted for the disposal of hospital waste are in existence. However, they suffer from a number of limitations, such as safety problems, including leaks and other shortcomings which make them not particularly suitable to institutional applications where relatively unskilled workers are employed as operators. Moreover, since these devices are employed for the disposal of glass, plastic and other implements, the wear and tear on the machines is considerable. The users are generally incapable of keeping the machines in proper adjustment to avoid damage. They thus require either the presence of a skilled mechanic on staff or frequent calls by the manufacturer's skilled service mechanic.

Since the advent of the disposal syringe and other disposable medical articles, there has also arisen a need for a method to prevent their misuse and theft. In hospitals today there is a tremendous volume of these articles which after being used must be accounted for by some method or another, all of which takes precious time. There is an ever-growing problem with theft of used syringes for illegal intra-venous drug use. There is a need for a shredding and disposing device which is sanitary, quick to use and can handle large volumes.

Devices for shredding waste material not well-developed. Currently, syringes and needles are simply thrown into sharps containers and stored until collected. Storage of whole syringes and needles also pose safety risks for waste disposal collection personnel. There exists the possibility of containers breaking and collection personnel accidentally getting stuck with contaminated needles. Accordingly, it is desirable to provide a device and method for disposing and reducing the volume of waste material.

### BRIEF DESCRIPTION OF THE DRAWINGS

FIG. 1 is a front perspective view of one illustrative embodiment of the device.

FIG. 2 shows a side perspective view of another illustrative embodiment of the device.

FIG. 3 is a top perspective view of one illustrative embodiment of the device.

FIG. 4 is an exploded view of an illustrative embodiment of the external housing of the device in relation to a waste receptacle container.

FIG. 5 is an exploded view of one illustrative embodiment of the internal housing of the device.

FIG. 6 shows a side perspective view of another illustrative embodiment of the device with the front panel of the internal housing in the open position, and the motor and filter units in mechanical communication with the intake chamber.

FIG. 7 is a rear perspective view of one illustrative embodiment of the internal housing of the device.

FIG. 8 is a front perspective view of an illustrative embodiment of the internal housing of the device.

FIG. 9 shows a top perspective view of another illustrative embodiment of the internal housing of the device.

FIG. 10 is a perspective view of one illustrative embodiment of the device in relation to a waste receptacle container.

FIG. 11 shows a perspective view of an illustrative embodiment of protective device engaged with medical waste material.

### DETAILED DESCRIPTION

The disclosure relates to a device for shredding waste and method for reducing the volume of waste material. Provided is a device for processing waste, such as medical and hospital waste. The device comprises a housing having a longitudinal axis, a chamber defining a passageway and having a first opening that communicates with the atmosphere and a second opening that communicates with the interior of the housing. A waste receptacle may be positioned at the second opening of the chamber in order to receive processed waste material. A cutting member is contained within the chamber for cutting and shredding waste that has been inserted into the chamber of the device. The device includes power means to drive the cutting element. The device is connected to an electrical supply source to provide power to the device.

According to certain illustrative embodiments, the electrical device further comprises a plunger member having dimensions which allows for insertion of the plunger member into said first opening of the chamber to assist with advancing waste material through the chamber toward the cutting and shredding member. The elongated handle of the plunger member is comprised of a cylindrical handle. The cylindrical handle may include a circumferential thumb rest to improve gripping and manual dexterity when in use. Alternatively, the elongated handle may be provided with indentations to improve gripping and manual dexterity when in use.

According to additional illustrative embodiments, the device further comprises a cutting member capable of shredding waste material. Without limitation, and by way of illustration only, the device may be comprised of twist drill bits, step drill bits, unibits, center and spotting drill bits, core drill bits, countersink bits, ejector drill bits, gun drill bits, indexable drill bits, left-hand bits, metal spade bits, straight fluted bits and diamond core bits. According to certain embodiments, the cutting member of the device may include a member that can be a rabbet bit. According to further embodiments, the cutting member may be comprised of a hardened steel.

According to certain embodiments, the device may include an electric motor to rotate, reciprocate, and/or vibrate the cutting member. The electric motor may be powered by batteries or any other source of suitable electric current. The motor may rotate the cutting member(s) about their respective rotary axes at variable rotational speeds. The device may also include a timed stopping mechanism to shut off the motor after a pre-determined period of time. According to further embodiments, the means to drive the cutting member may be powered by a 120 v/60 Hz motor.

According to additional illustrative embodiments, the device further comprises a vacuum pump and air filter system. The vacuum pump and air filter system may be powered by batteries or any other source of suitable electric current. The vacuum pump may be utilized to move air in or out of the device for the purpose of extracting gas or vapor that may be emitted from the waste material. Without limitation, and by way of illustration, the device may be comprised of vacuum pumps, such as positive displacement pumps, momentum transfer pumps, molecular pumps and entrapment pumps. According to further embodiments, the vacuum pump may be powered by a 120 v/60 Hz/1.25 amps. The air filter may be utilized to remove solid particulates such as dust, pollen, mold, and bacteria from the air. The air filter may also be utilized to remove contaminants from the medical waste being processed in the inside environment of the housing. Without limitation, and by way of illustration, the device may be comprised of air filters, such as chemical, deep pleated, electronic, fiberglass or polyester, HEPA, ordinary flat or pleated, permanently charged electrostatic and washable/reusable. According to other illustrative embodiments, the device further comprises an air filter that is a HEPA filter.

According to further embodiments, the electrical device further comprises an room (air) purifier. Without limitation, and by way of illustration, the device may be comprised of air purifiers, such as commercial grade air purifiers that can be manufactured as either small stand-alone units or larger units that can be affixed to an air handler unit (AHU) or to an HVAC unit found in the medical, industrial, and commercial industries.

According to further embodiments, the electrical device further comprises a plurality of safety switches and a momentary on/off switch for purposes related to safe operation of the device and providing extra protection against electrocution. Without limitation, and by way of illustration, the device may be comprised of actuator operated switches, hinge operated actuation switches, cam operated actuation switches and non-contact (non-mechanical) actuation switches. The switches may be positioned within the housing of the device to prevent unintended operation of the device. The safety actuator switches and a momentary on/off switch may be connected to a circuit breaker. According to certain illustrative embodiments, the electrical device further comprises a circuit breaker that is 20 amps.

According to other embodiments, the housing is provided as a single integral piece that can be attached to internal components for replaceability purposes. According to other illustrative embodiments, but not in limitation, the device further comprises external and internal housings. According to certain illustrative embodiments, the external housing is about 15 to 20 inches in height, about 5 to 10 inches in width and about 9 to 12 inches in depth. According to certain illustrative embodiments, the electrical device further may comprise an external housing which is about 15 inches in height, about 6 inches in width and about 10 inches in depth. According to additional illustrative embodiments, the electrical device further may comprise a housing with a removable top portion. According to certain illustrative embodiments, the electrical device further comprises an external housing with a removable bottom portion. According to other illustrative embodiments, the device further comprises a removable bottom portion that is hingedly attached to the external housing. According to other embodiments, the external housing of the device comprises a handle or plurality of handles for facilitating its placement and transportation.

According to further embodiments, the plunger member of the device is comprised of a light source positioned externally or internally allowing for increased visibility, including a timer to switch off the light at specific intervals. According to other illustrative embodiments, the device further comprises a plurality of light sources positioned externally and internally, including a plurality of timers to switch off the lights at specific intervals.

The elongated handle of the plunger member is comprised of a cylindrical handle. The cylindrical handle may include a circumferential thumb rest to improve gripping and manual dexterity when in use. Alternatively, the elongated handle may be provided with indentations to improve gripping and manual dexterity when in use. According to other embodiments, the plunger member includes a cylindrical handle, the center portion of which is comprised of a softer or less rigid material than the other handle portions that extend away from the central handle portion to improve gripping and manual dexterity when in use.

Provided is a method for processing waste, the method comprises inserting waste material into the passageway of the chamber of the waste processing device.

Further provided is a method for processing waste, the method comprises inserting waste material into the passageway of the chamber of the waste processing device; and advancing the waste material through the passageway of the chamber of the waste processing device with a plunger member.

According to certain illustrative embodiments, the method for processing waste comprises inserting waste material into the passageway of the chamber of the waste processing device; advancing the waste material through the passageway of the chamber of the waste processing device with a plunger member; and depressing a momentary on/off switch.

According to other embodiments, the method for processing waste comprises inserting waste material into the passageway of the chamber of the waste processing device; advancing the waste material through the passageway of the chamber of the waste processing device with a plunger member; depressing a momentary on/off switch; and connecting a room (air) purifier to the device.

The certain illustrative embodiments of the device will be described in further detail with respect to the Figures. It should be noted that the device should not be limited to the illustrative embodiments depicted by the Figures.

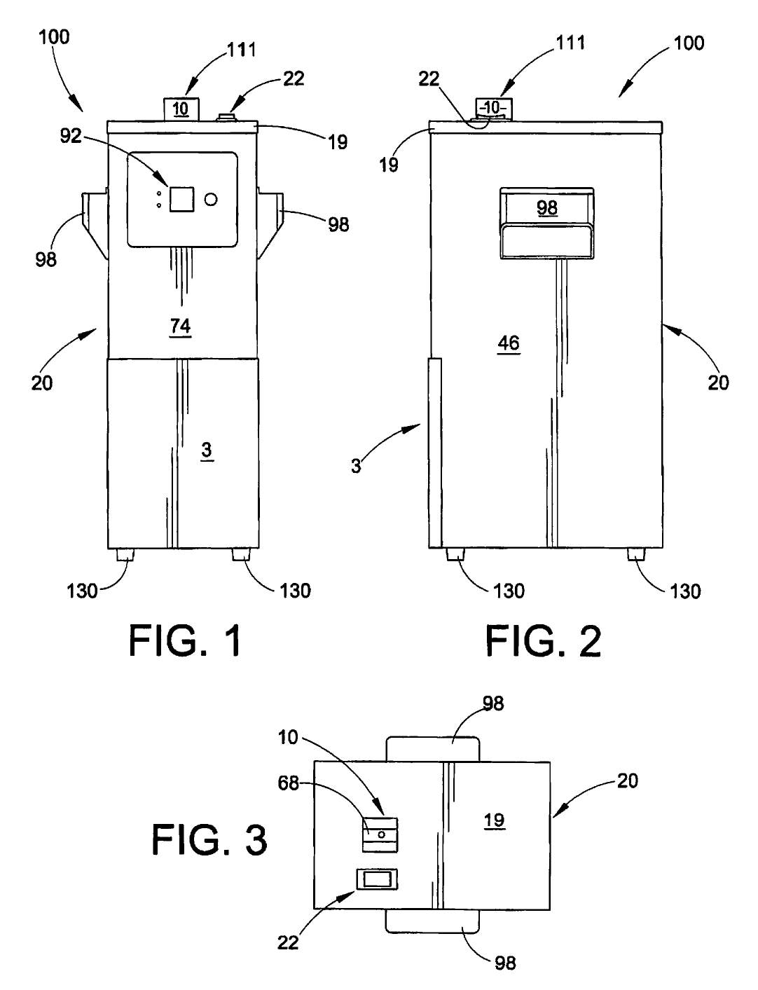

As shown in FIG. 1, the waste processing device (100) comprises an external housing (20) that comprises four sides (only front side (74) is shown). The external housing (20) contains the material intake chamber (10) through which waste material is processed. Waste material is inserted into the first end of the chamber (111). The external housing (20) also contains the internal housing, motor unit that is attached to the internal housing and filter system (all not shown). The external housing (20) includes a plurality of external handles (98) handles for facilitating placement and transportation of the device (100). The external housing (20) further includes a top panel (19) that is secured to the external housing (20). The top panel (19) includes a momentary on/off switch (22) and a first aperture (not shown) through which the chamber (10) passes. The external housing (20) additionally includes feet (130) attached to the bottom of the device (100). The feet (130) may be manufactured from any heavy duty and durable material, including, without limitation, aluminum, plastic, rubber, steel, metal, metal alloy, composite materials, or any other suitable material sufficient in strength to support the device (100). Also shown is the front panel (3), of the internal housing (not shown), which can be opened to allow for placement of a waste receptacle (not shown) inside the device (100).

FIG. 2 is a side perspective view of another illustrative embodiment of the device (100). Only right side (46) of the external housing (20) is shown. The external housing (20) contains the material intake chamber (10) through which waste material is processed by insertion into the first end of the chamber (111). The external housing (20) includes an external handle (98) and a top panel (19) that is secured to the external housing (20). The top panel (19) includes a momentary on/off switch (22) and a first aperture (not shown) through which the chamber (10) passes. The external housing (20) additionally includes feet (130) attached to the bottom of the device (100). Also shown is the front panel (3), of the internal housing (not shown), in the closed position.

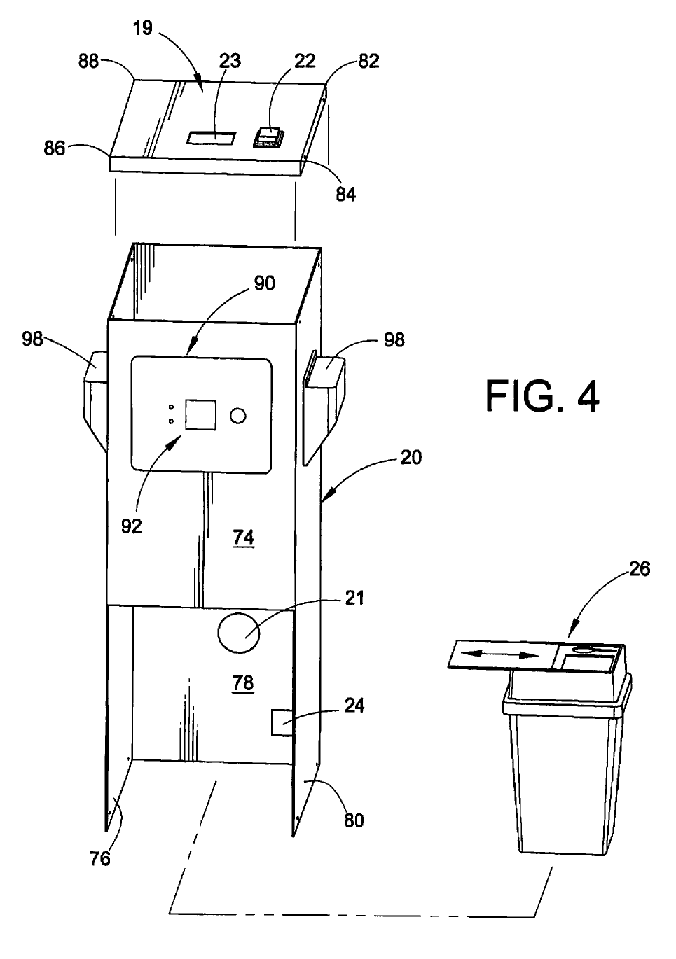

Turning to FIG. 3, a top perspective view of one illustrative embodiment of the device (100) is shown. The external housing (20) includes a plurality of external handles (98) and a top panel (19) that is secured to the external housing (20). The top panel (19) includes a momentary on/off switch (22) and a first aperture (not shown) through which the chamber (10) passes. A cutting member (68) is located in a position within the chamber for shredding waste material.

FIG. 4 shows an exploded view of an illustrative embodiment of the external housing of the device (100). The device comprises an external housing (20) that comprises four sides (74, 76, 78, 80). The external housing (20) contains the chamber, internal housing, motor unit that is attached to the internal housing and filter system (all not shown). The external housing (20) includes a top panel (19) that is secured to the external housing (20) by locking mechanisms (82, 84, 86, 88). The means for securing the top panel (19) to the external housing (20) may include, for example, magnets, buckles, snaps, clips, screws, rivets, fasteners and the like. The top panel (19) includes a momentary on/off switch (22) and a first aperture (23) through which the material intake chamber (not shown) passes. The rear side (78) of the external housing (20) also includes a second aperture (21) that acts as an outlet for fresh air to assist operation of the vacuum motor (not shown). Side (78) of the external housing (20) includes a circuit breaker re-set button (24). The front side (74) of the external housing (20) also includes a digital read out panel (90) which tracks each time the motor is activated, one of its features includes, without limitation, tracking the amount of waste material (e.g., needles and syringes) passing through the chamber into the waste receptacle or sharps container (26) which can be positioned within the external housing (20) of the device (100). A plurality of external handles (98) handles is also attached to the (external housing (20) for assistance with transporting the device (100).

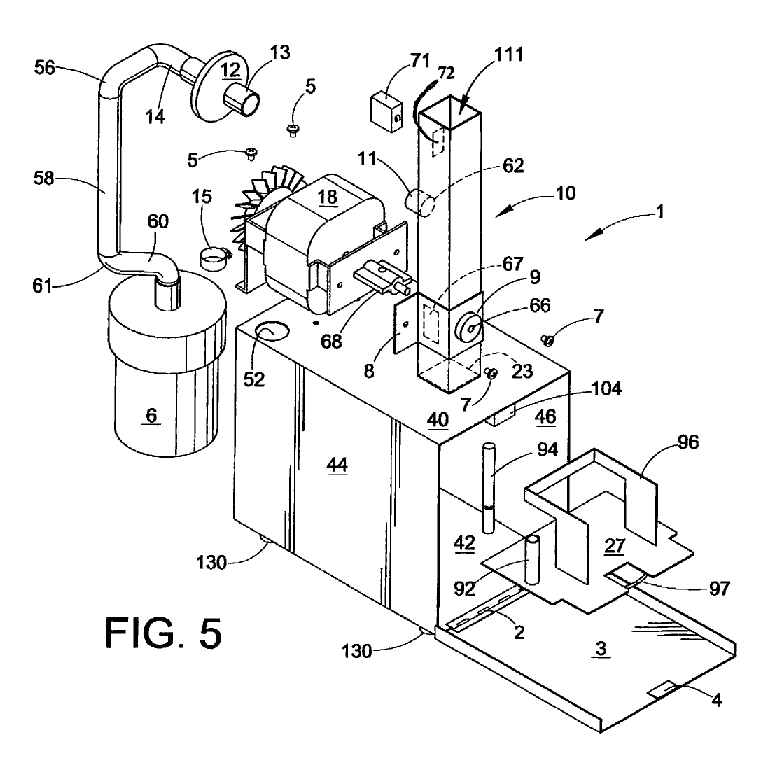

As shown in FIG. 5, the waste processing device (100) comprises an internal housing (1) having a top end (40), bottom end (42), and two sides (44, 46). The internal housing (1) includes a front panel (3) that is attached to the bottom end (42). The front panel (3) is easily opened, due to the hinge assembly, which allows for the placement of a waste receptacle (not shown) into the device (100). The internal housing (1) is shown in the open position, whereby the front panel (3) is hingedly attached. The means for attaching the front panel (3) to the bottom end (42) may include, for example, buckles, snaps, clips, hinges, screws, rivets, fasteners and the like (2). The front panel (3) is secured to top end (40) of the internal housing (1) by a locking mechanism (4) that mates to a corresponding attachment (104) on the top end (40). The means for securing the front panel (3) to the top end (40) may include, for example, magnets, buckles, snaps, clips, screws, rivets, fasteners and the like. The internal housing (1) includes a vacuum motor (6) that is mounted thereon. According to certain embodiments, the vacuum motor (6) is mounted to the back panel (not shown). The means for securing the vacuum motor (6) to the back panel (not shown) may include, for example, clips, screws, rivets, fasteners and the like. During use of the device, the vacuum motor (6) and motor (18) operate at the same time to remove all possible aerosol emissions generated from the processing of the waste material.

The internal housing (1) may also include a spring loaded platform (27) at the bottom end (42) onto which a waste disposal receptacle, such as a Bio-Hazard sharps container (not shown) is placed for receiving shredded material that is emptied through the second end (not shown) of the chamber (10). The height of the spring loaded platform (27) is adjustable via its two slotted rods (92, 94) for raising the waste disposal receptacle in order to allow contact with a second safety actuator switch (not shown). The width of the spring loaded platform (27) is adjustable via its post (96) for receiving waste disposal receptacles of various dimensions. The spring loaded platform (27), slotted rods (92, 94), post (96) and platform handle (97) may be manufactured from any heavy duty and durable material, including, without limitation, aluminum, plastic, steel, metal, metal alloy, composite materials, or any other suitable material sufficient in strength to support the components of the device. The spring loaded platform (27) also includes a platform handle (97) to engage the platform (27) into the upper locked position in order to ensure a waste receptacle container, which has been loaded onto the platform (27), is properly aligned and makes contact with the second actuator switch (not shown). The first safety actuator switch (71) is attached to the top end (40) of the internal housing (1). The second safety actuator switch (not shown) makes contact with the top portion of a waste disposal receptacle after the receptacle is placed into proper position on the spring loaded platform (27) and the spring loaded mechanism of the platform is engaged by the user causing the platform to raise.

The internal housing (1) delineates a first aperture (23) through which the material intake chamber (10) passes. Waste material is inserted into the first end of the chamber (111). The substantially rigid chamber (10) may be manufactured from any heavy duty and durable material, including, without limitation, aluminum, plastic, steel, metal, metal alloy, composite materials, or any other suitable material sufficient in strength to withstand the force through which waste material passes. The chamber (10) houses the cutting member (68) that is positioned in a first location (67) within the chamber (10) and is attached to the motor (18). A bearing (9) located on the rear portion of the chamber (10) is attached to the motor via a set screw (66). The motor mount bracket (8) is attached to the motor (18) by a set of fasteners (7). The motor mount plate (17) is attached to the top end (40) of the internal housing (1) by a plurality of fasteners (5). The fasteners (5, 7) may include, for example, buckles, snaps, clips, grommets, hinges, screws, rivets and the like (2). The means for securing the chamber (10) to the motor mount bracket (8) may include, for example, clips, screws, rivets, fasteners and the like. The motor mount may be comprised of a heavy gauge steel with rubber fasteners.

The internal housing (1) further delineates a third aperture (52) through which the first elbow plumbing or pipe connector/fitting (“elbow”) (60) passes. The first elbow (60) is attached to the top portion of the vacuum motor (6) and is held in place by a hose clamp (15) which is circumferentially arranged about the vacuum motor (6). The first end of the second elbow (61) is attached to the first elbow (60) and the second end of the second elbow (61) is attached to the first straight plumbing or pipe connector/fitting (“pipe”) (58). The first pipe (58) is attached to the third elbow (56) which is attached to the fourth elbow (14). The fourth elbow (14) is attached to the first end of the filter (12), such as a high efficiency particulate air (“HEPA”) filter. The second end of the filter (12) is attached to the second pipe (13) which attaches to the vacuum pick-up tube (11). The main portion of the vacuum pick-up tube (11) is positioned within the chamber (10) at a second location (62) in close proximity to the first location (67) in which the cutting member (68) is positioned within the chamber (10). Capturing any potential biomedical contaminants aerosols that are emitted during the shredding process is accomplished through the use of the vacuumed “HEPA” filter system.

The first safety actuator switch (71) is positioned in a third location (72) within the chamber (10). The first safety actuator switch (71) makes contact with the plunger member (not shown) after the plunger (not shown) is inserted into the chamber (10).

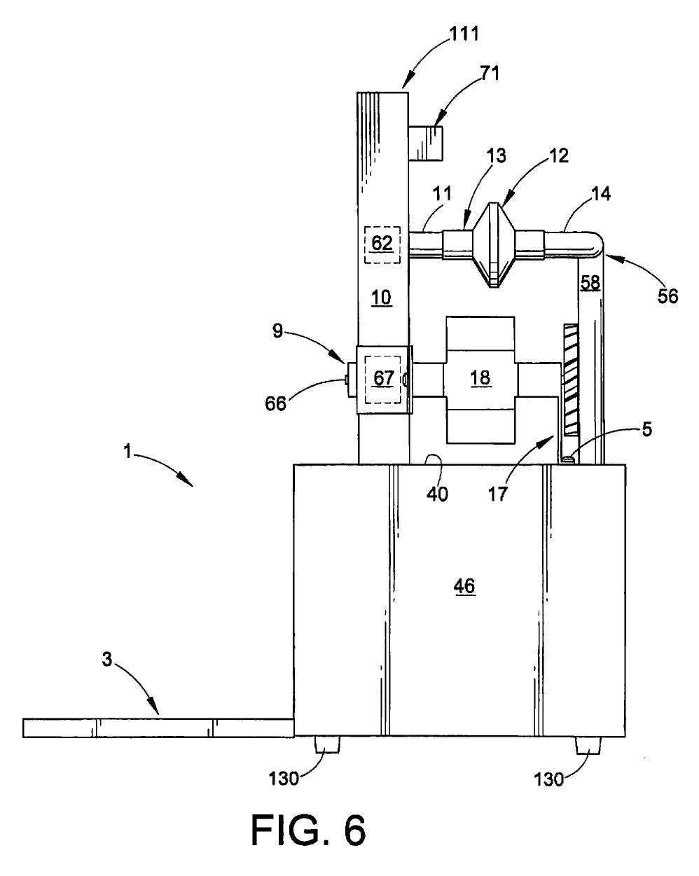

FIG. 6 is a side perspective view of another illustrative embodiment of the internal housing (1) of the device, and in particular, the right side (46) on the internal housing (1). The front panel (3) is shown in the open position, and the motor (18) and filter (12) units are in mechanical communication with the intake chamber (10). The chamber (10) houses the cutting member (not shown) that is positioned in a first location (67) within the chamber (10) and is attached to the motor (18). A bearing (9) located on the rear portion of the chamber (10) is attached to the motor via a set screw (66). The motor mount plate (17) is attached to the top end (40) of the internal housing (1) by a plurality of fasteners (5). The first pipe (58) is attached to the third elbow (56) which is attached to the fourth elbow (14). The fourth elbow (14) is attached to the first end of the filter (12), such as a high efficiency particulate air (“HEPA”) filter. The second end of the filter (12) is attached to the second pipe (13) which attaches to the vacuum pick-up tube (11). The main portion (not shown) of the vacuum pick-up tube (11) is positioned within the chamber (10) at a second location (62) in close proximity to the first location (67) in which the cutting member (68) is positioned within the chamber (10). Waste material is inserted into the first end of the chamber (111). Feet (130) are also shown attached to the bottom of the device.

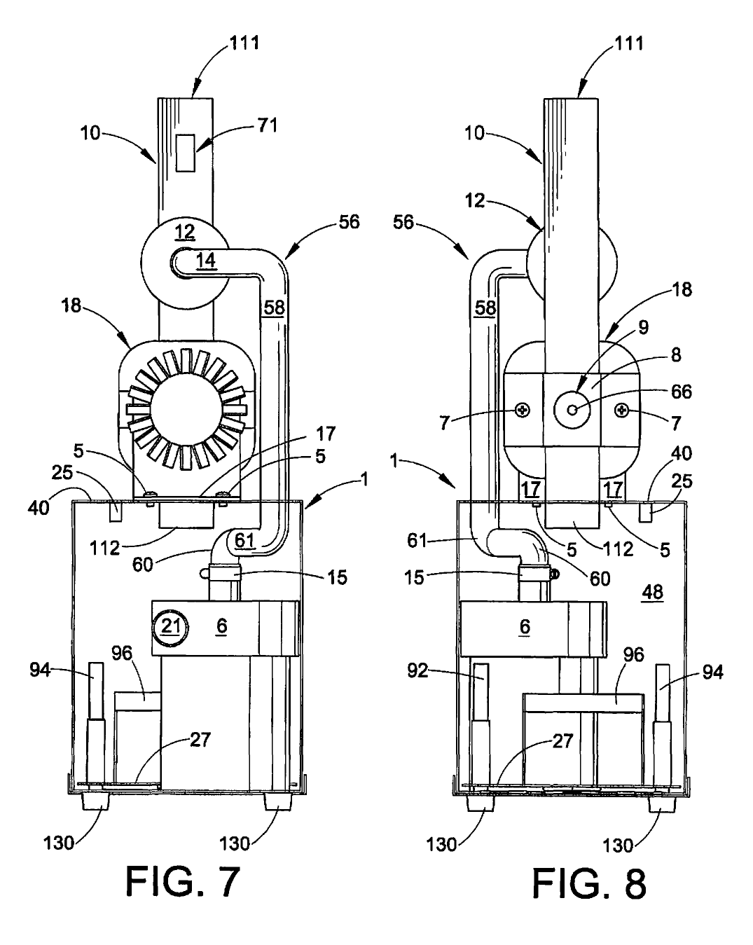

FIG. 7 shows a rear perspective view of one illustrative embodiment of the internal housing (1) of the device. The vacuum motor (6) is mounted to the back panel (not shown) of the internal housing (1). The first elbow (60) is attached to the top portion of the vacuum motor (6) and is held in place by a hose clamp (15). The first end of the second elbow (61) is attached to the first elbow (60) and the second end of the second elbow (61) is attached to the first pipe (58). The internal housing (1) delineates the third aperture (not shown) through which the first pipe (58) passes. The first pipe (58) is attached to the third elbow (56) which is attached to the fourth elbow (14). The fourth elbow (14) is attached to the filter (12) which is close proximity to the motor (18). The motor mount plate (17), which is attached to the motor (18), is attached to the top end (40) of the internal housing (1) by a plurality of fasteners (5). The internal housing (1) further delineates the first aperture (not shown) through which the material intake chamber (10) passes. Waste material, inserted into the first end of the chamber (111) for shredding, is emptied through the second end (112) of the chamber (10) in to a waste receptacle (not shown). The first safety actuator switch (71) is also shown in relation to the upper portion of the chamber (10).

The internal housing (1) may also include a spring loaded platform (27) onto which a waste disposal receptacle, such as a Bio-Hazard sharps container (not shown) is placed for receiving shredded material that is emptied through the second end (112) of the chamber (10). The height of the spring loaded platform (27) is adjustable via its two slotted rods (only 94 is shown) for raising the waste disposal receptacle in order to allow contact with the second safety actuator switch (25) which is attached to the top end (40) of the internal housing (1). The width of the spring loaded platform (27) is adjustable via its post (96) for receiving waste disposal receptacles of various dimensions. The second safety actuator switch (25) makes contact with the top portion of a waste disposal receptacle after the receptacle is placed into proper position on the spring loaded platform (27) and the spring loaded mechanism of the platform is engaged by the user causing the platform to raise. Feet (130) are also shown attached to the bottom of the device.

As shown in FIG. 8, the vacuum motor (6) is mounted to the back panel (48) of the internal housing (1). The first elbow (60) is attached to the top portion of the vacuum motor (6) and is held in place by a hose clamp (15). The first end of the second elbow (61) is attached to the first elbow (60) and the second end of the second elbow (61) is attached to the first pipe (58). The internal housing (1) delineates the third aperture (52) through which the first pipe (58) passes. The first pipe (58) is attached to the third elbow (56) which is attached to the fourth elbow (not shown). The fourth elbow (14) is attached to the filter (12). The internal housing (1) further delineates the first aperture (not shown) through which the material intake chamber (10) passes. Waste material is inserted into the first end of the chamber (111). The chamber (10) houses the cutting member (not shown) that is attached to the motor (18). The bearing (9) located on the rear portion of the chamber (10) is attached to the motor (18) via a set screw (66). The motor mount bracket (8) is attached to the motor (18) by a set of fasteners (7). The motor mount plate (17) is attached to the top end (40) of the internal housing (1) by a plurality of fasteners (5). The height of the spring loaded platform (27) is adjustable via its two slotted rods (92, 94) to allow the waste disposal receptacle (not shown) to contact the second safety actuator switch (25) which is attached to the top end (40) of the internal housing (1). The width of the spring loaded platform (27) is adjustable via its post (96). Feet (130) are also shown attached to the bottom of the device.

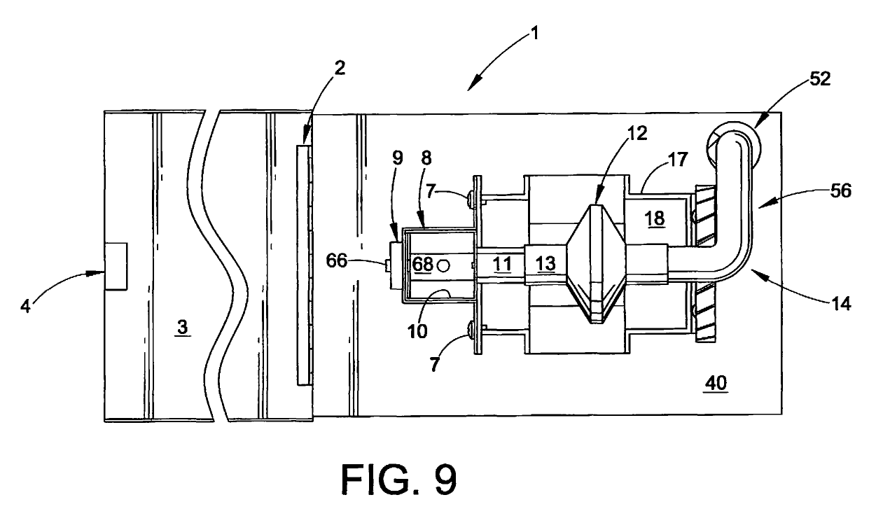

FIG. 9 is a top perspective view of another illustrative embodiment of the internal housing (1) of the device, and in particular, the top end (40) on the internal housing (1). The front panel (3), including its locking mechanism (4), is shown in the open position, and is attached to the bottom end (not shown) of the internal housing (1). The front panel (3) is easily opened, due to the hinge assembly, which allows for the placement of a waste receptacle (not shown) into the device. The motor (18) and filter (12) units are in mechanical communication with the intake chamber (10). The chamber (10) houses the cutting member (68) that is attached to the motor (18). A bearing (9) located on the rear portion of the chamber (10) is attached to the motor via a set screw (66). The motor mount plate (17) is attached to the top end (40) of the internal housing (1) by a plurality of fasteners (not shown). The motor mount bracket (8) is attached to the chamber (10) by a plurality of fasteners (7). The third elbow (56), which passes through the third aperture (52), is attached to the fourth elbow (14). The fourth elbow (14) is attached to the first end of the filter (12) which is attached to the second pipe (13) that attaches to the vacuum pick-up tube (11).

The internal and external housings of the device may be constructed of any material that can support the engagement of device components. Without limitation, suitable material that may be used to construct the internal and external housings of the device comprises metal, metal alloys, plastic, glass, composite materials, or combinations thereof. The internal and external housings may be manufactured through the use of stamping and pressing tools and welding equipment.

The external housing of the disclosed device is easily fitted and removed, due to the slide-over design, which ensures ease of maintenance of the device's inner components.

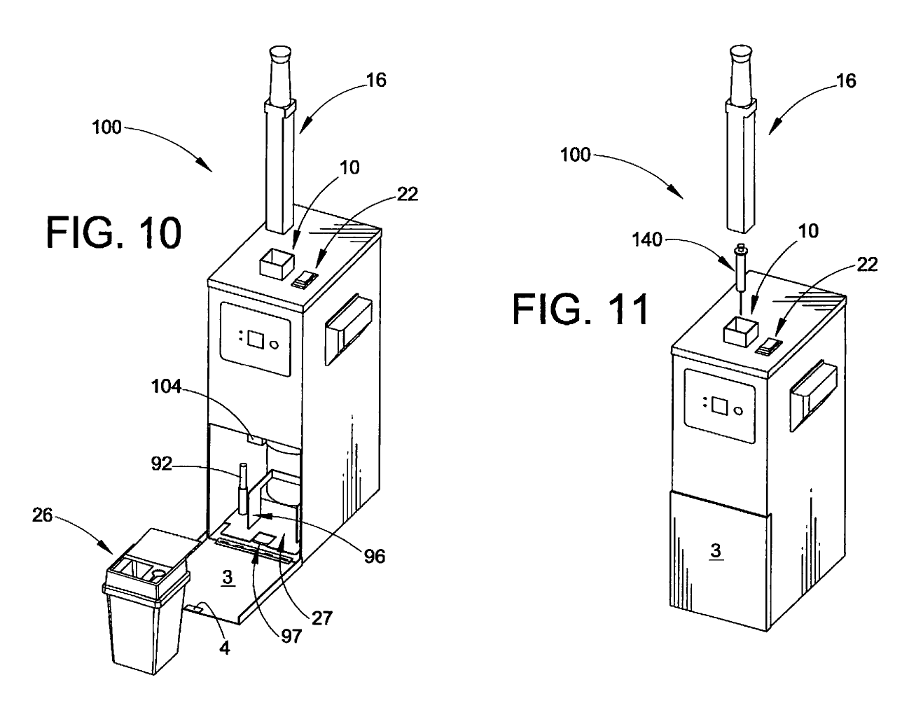

As shown in FIG. 10, the device (100) is shown in relation to a waste disposal receptacle, such as a Bio-Hazard sharps container (26) that may be placed onto the spring loaded platform (27) for receiving shredded material that is emptied through the second end (not shown) of the chamber (10). The height of the spring loaded platform (27) is adjustable via its two slotted rods (only 92 is shown) for raising the waste disposal receptacle in order to allow contact with the second safety actuator switch (not shown). The width of the spring loaded platform (27) is adjustable via its post (96) for receiving waste disposal receptacles of various dimensions. The spring loaded platform (27) also includes a platform handle (97) to engage the platform (27) into the upper locked position in order to ensure a waste receptacle container, which has been loaded onto the platform (27), is properly aligned and makes contact with the second actuator switch (not shown). The front panel (3), shown in the open position, includes a locking mechanism (4) that mates to a corresponding attachment (104). The top panel (19) of the device (100) includes a momentary on/off switch (22) and a first aperture (not shown) through which the material intake chamber (10) passes. Also shown is a plunger member (16) having dimensions which allows for its insertion into the chamber (10) to assist with advancing material through the device.

FIG. 11 shows the device (100) in use. Subsequent to placement of the waste receptacle (not shown) onto the spring loaded platform (not shown) that is located within the device (100), the front panel (3) is closed. Following insertion of waste material, such as used medical syringes (140) into the chamber, the momentary on/off switch (22) is depressed and the plunger (16) is inserted into the chamber (10) to assist with advancing the waste material through the device.

During use of the device, the vacuum motor (6) as shown in FIGS. 5, and 7-9 and motor (18) as shown in FIGS. 5-9 operate at the same time to remove all possible aerosol emissions from the waste material.

The device is capable of shredding entire plastic syringes, including needles, into tiny particles by inserting them into the chamber of the device with the use of a plunger. The resulting shredded material is then deposited into a Bio-Hazard sharps container.

The device eliminates handling risks and reduces the volume of the discarded syringes and needles. Reducing the volume of discarded syringes and needles also increases the amount of syringes and needles that can be stored in a waste receptacle or Bio-Hazard sharps containers (approximately a 6 to 1 ratio), thereby translating into substantial savings in handling fees, less land fill debris, less likelihood of handlers being pricked with needles, and prevents thieves from stealing the syringes and needles.

Moreover, an increased surface area can be more easily treated through shredding the syringe capsule, thereby making sterilization more effective. The increased surface area of the waste material can be treated to sterilize any infectious pathogens.

In addition, obliteration of syringes and needles is a deterrent with respect to second hand use of infected medical products. Although there are federal guidelines for preventing theft of controlled substances in health care facilities, the theft of used syringes with respect to illegal intra-venous drug use is on the rise. Hospitals, nursing homes and pharmacies are reporting alarming rates of stolen syringes and needles. Moreover, thefts by health care workers are not uncommon, mainly because health care facilities (of physicians, physical therapists, advanced life support personnel, physician assistants, athletic trainers, occupational therapists, respiratory therapists, nurse practitioners, nurse midwives and dietitians) is where many popularly abused drugs are located.

It has been found that the device efficiently shreds needles and plastic in milliseconds. After medical practitioners have administered injections, the needle and syringe can together be placed into the device for obliteration, eliminating any second hand use. Other devices utilize electricity to destroy the needle without affecting the syringe. However, the resulting air particulates that are emitted is an environmental risk. Conversely, the disclosed device destroys the syringe and renders the needle unusable without the concern of any potentially harmful aerosols that may be emitted during its operation.

The device also shreds material in a safe manner. For safety purposes, four (4) conditions must exist in order for the motor to operate. First, a waste receptacle (e.g., Bio-Hazard sharps container) must be properly positioned onto the loading platform of the device. Second, the loading platform, which may be comprised of stainless steel, is designed to hold the receptacle or container in place and is adjustable in size to accommodate variable sizes of containers. The platform is comprised of two (2) slotted posts, which may be comprised of hardened steel, and connects to the loading platform via a spring loaded armature that locks the inserted container into proper alignment so that the container makes contact with the first actuator switch. Third, after the waste material intended for shredding is loaded in the intake chamber, the plunger is inserted into the chamber which includes a second safety actuator that makes contact with the plunger pressing the actuator to its on position. Fourth, depressing the momentary on/off switch in combination with actuation of the aforementioned safety actuator switches, completes the electrical circuit and activates the motor to shred the inserted material. A wire harness is connected in a series to the actuator switches, 20 amp circuit breaker, momentary on/off button, and a electrical supply source. Once the container is full, the hinged panel is opened, the spring loaded armature on the loading platform is pulled downward, and the container is removed for proper disposal according to state laws and regulations.

The shape of the device can vary greatly, and there is no particular shape to which the electrical-shredding device must be limited. In certain embodiments, the electrical-shredding device comprises an axisymmetric shape. In other embodiments, the electrical-shredding device comprises a substantially rectangular shape.

While the waste disposal device and method for reducing the volume of waste material has been described in connection with various illustrative embodiments, as shown in the Figures, it is to be understood that other similar embodiments may be used or modifications and additions may be made to the described embodiments for performing the same functions. Therefore, the shredding device and method for reducing the volume of waste material should not be limited to any single embodiment, but rather construed in breadth and scope in accordance with the recitation of the appended claims.

I claim:

1. A waste processing device comprising:
a housing;
a chamber at least partially located within said housing, said chamber having first and second openings defining a passageway for waste material;
a cutting member at least partially located within said chamber; and
means to drive said cutting member.

2. The waste processing device of claim 1, further comprising a plunger member having a dimension which allows for insertion of said plunging member into said first opening of said chamber to advance waste material at least partially through said chamber.

3. The waste processing device of claim 1, wherein said cutting member comprises a center and spotting drill bit, core drill bit, countersink bit, diamond core bit, ejector drill bit, gun drill bit, indexable drill bit, left-hand bit, metal spade bit, rabbet bit, step drill bit, straight fluted bit, twist drill bit, or unibit.

4. The waste processing device of claim 1, wherein said means comprises an electric motor.

5. The waste processing device of claim 1, further comprising a vacuum motor in communication with an air filter.

6. The waste processing device of claim 5, wherein said air filter comprises a HEPA filter.

7. The waste processing device of claim 1, further comprising a plurality of safety actuator switches.

8. The waste processing device of claim 1, further comprising a momentary on/off switch.

9. The waste processing device of claim 1, further comprising a spring loaded platform onto which a waste disposal receptacle may be positioned.

10. The waste processing device of claim 1, further comprising a circuit breaker.

11. The waste processing device of claim 1, wherein said housing comprises a removable top portion.

12. The waste processing device of claim 1, wherein said housing comprises a removable bottom portion.

13. The waste processing device of claim 12, wherein said removable bottom portion is hingedly attached to said housing.

14. The waste processing device of claim 1, further comprising an internal housing.

15. The waste processing device of claim 1, wherein said housing comprises a plurality of external handles.

16. The waste processing device of claim 1, wherein said housing comprises a digital display.

17. The waste processing device of claim 1, further comprising a light source disposed within said device.

18. The waste processing device of claim 1, further comprising a room purifier connected to said device.

19. A waste processing device comprising:
a housing;
a cutting member positioned within said housing;
means for driving said cutting member;
a vacuum for extracting material generated during operation of said device; and
a filter for filtering the internal atmosphere of said device.

20. The waste processing device of claim 19, wherein said cutting member comprises a center and spotting drill bit, core drill bit, countersink bit, diamond core bit, ejector drill bit, gun drill bit, indexable drill bit, left-hand bit, metal spade bit, rabbet bit, step drill bit, straight fluted bit, twist drill bit, or unibit.

21. The waste processing device of claim 19, wherein said means for driving said cutting member comprises an electric motor.

22. The waste processing device of claim 19, wherein said filter comprises a HEPA filter.

23. The waste processing device of claim 19, further comprising a plurality of safety actuator switches.

24. The waste processing device of claim 19, further comprising a momentary on/off switch.

25. The waste processing device of claim 19, further comprising a spring loaded platform onto which a waste disposal receptacle may be positioned.

26. The waste processing device of claim 19, further comprising a circuit breaker.

27. The waste processing device of claim 19, wherein said housing comprises a removable top portion.

28. The waste processing device of claim 19, wherein said housing comprises a removable bottom portion.

29. The waste processing device of claim 28, wherein said removable bottom portion is hingedly attached to said housing.

30. The waste processing device of claim 19, further comprising an internal housing.

31. The waste processing device of claim 19, wherein said housing comprises a plurality of handles.

32. The waste processing device of claim 19, wherein said housing comprises a digital display.

33. The waste processing device of claim 19, further comprising a light source disposed within said device.

34. The waste processing device of claim 19, further comprising a room purifier connected to said device.
